(19) United States
(12) Patent Application Publication
(10) Pub. No.: US 2015/0130261 A1
(43) Pub. Date: May 14, 2015

(54) Method of Designing and Producing Carbon Fiber Wheels

(71) Applicant: Patrick Warren, Los Angeles, CA (US)

(72) Inventor: Patrick Warren, Los Angeles, CA (US)

(21) Appl. No.: 14/075,191

(22) Filed: Nov. 8, 2013

(51) Int. Cl. B29C 70/12; B60B 3/00; B60B 3/10; B60B 3/04; B29C 70/54; B29C 37/00

(52) U.S. Cl. CPC B29C 70/12; B29C 70/545; B29C 37/00; B60B 3/10; B60B 3/04; B60B 3/001; B60B 2310/204; B60B 2310/228; B60B 2310/30; B60B 2360/36; B60B 2900/111; B60B 2900/311; B29L 2031/32
USPC 301/64.101; 264/118; 264/40.1; 29/894.36

(57) ABSTRACT

A method of designing and producing the spoke section of a vehicle wheel using chopped carbon fiber pre-impregnated composite material is provided, wherein the method allows wheel designers to machine several different wheel designs, wheel diameters, and wheels with different offsets without using different material molds for each, as is customary with traditional carbon fiber reinforced plastic wheels designed using a layup procedure. The present method greatly reduces material waste, engineering design effort for each wheel, and the cost of each wheel over existing methods by using a single mold that can accommodate different wheel designs.

### BACKGROUND OF THE INVENTION

1. Field of the Invention

The present invention relates to automotive wheel manufacturing and methods of designing and producing composite wheels. More specifically, the present invention pertains to a new method of designing and producing a composite wheel spoke section using compression molded, chopped composite material that is machinable after being formed, along with a design process that allows several different wheel designs to be machined from a single material blank thereof.

Automotive wheels are well known structures that support the vehicle tires at each corner by way of support of the tire bead. High performance wheels are lightweight and high strength structures that can be specifically designed to reduce unsprung mass while being sufficiently durable for competition or rigorous use. High performance and exotic wheels are also popular accessory items that many consumers use to replace their stock counterparts, either for increased performance or for pure aesthetic reasons. The present invention is directed to a new method of manufacturing and designing high performance wheels, which aims to reduce the costs thereof while maintaining a high degree of wheel performance.

One example of particular interest in the field of high performance wheels are those that utilize carbon fiber reinforced plastics (CFRP) or similar composite materials in their structure. Such composite materials are well known for their high strength, high stiffness, and low density, which together provide a very strong wheel that is very light weight. However, with this increase in structural performance and reduced mass comes a tradeoff in engineering design complexity and overall cost (in terms of material costs, production costs, and design costs).

Carbon fiber wheels generally utilize a composite layup process in which directional carbon fiber pre-impregnated ply layers are overlaid on top of one another to form a ply stack-up, which is then vacuum bagged and placed into an autoclave for curing. The design process for this technique is expensive and technically complex. The ply orientations within the layup and the overall thickness in all areas of the wheel must be determined through careful engineering analysis, taking into account the local geometry, the capability of the given material, and the unique structural loading in all areas of the wheel. After the design phase, the resulting manufacturing process of each individual wheel takes considerable time, skill, and cost.

One of the primary issues in composite wheels manufacturing, and particularly carbon fiber material wheels, is that the design and production process is unique to each wheel design. Each wheel must be individually designed, analyzed, and manufactured using a composite layup that is unique to the wheel shape. The mold design of one wheel size and design cannot be readily shared with other wheel sizes and styles, and the variables of each must be individually accounted for in a separate mold. These variables include the wheel geometry, wheel size, wheel offset, and the wheel spoke design (among others). Making individual molds and ply layup schedules for each wheel design is very tedious and expensive, driving up the costs of composite wheels over their traditional metallic wheel counterparts. This in turn reduces their widespread use or use outside of high performance arenas.

The present invention relates to a new method of designing and producing composite wheels, and in particular carbon fiber wheel spoke designs that do not require specific molds for different sized wheels, those with different offsets, or bolt patterns. The present method utilizes chopped carbon fiber pre-impregnated composite material that can be formed into a shape using a compression molding technique. The resulting material is non-directional and conforms to the shape of the mold, wherein the chopped fibers are supported within a matrix in random directions to produce an overall quasi-isotropic material system. Using this material, the wheel spoke design process benefits and can utilize the fact that this material system is machinable after being formed. Further provided is an efficient design method that utilizes the chopped composite material system to create a wheel blank that is adaptable to different wheel designs while minimizing lost material during the machining process. Once the wheel design is machined, the wheel spoke can then be fastened to a traditional wheel barrel section, as is customary for three-piece wheels in the industry.

2. Description of the Prior Art

Devices have been disclosed in the prior art that relate to composite vehicle wheels. These include devices that have been patented and published in patent application publications, and generally relate to methods involving directional fibers and layup procedures for wheel production. The following is a list of devices and method of manufacturing deemed most relevant to the present disclosure, which are herein described for the purposes of highlighting and differentiating the unique aspects of the present invention, and further highlighting the drawbacks existing in the prior art.

One such method in the art is U.S. Pat. No. 4,294,490 to Woelfel, which discloses a composite wheel and method of manufacturing a composite vehicle wheel using fiber-reinforced resin, whereby a first set of reinforcing fibers are oriented randomly with respect to the wheel axis and a second set of the reinforcing fibers are oriented substantially parallel to the wheel axis. The proportion of random fibers to directional fibers is varied to provide different stiffness characteristics to the wheel and different strength properties thereto. While the Woelfel device is one related to composite vehicle wheels, its method and construction utilizes a layup of directional fibers to create the desired strength and stiffness characteristics of the given wheel, which requires specific molds for each wheel design and engineering design and analysis specific to each given wheel.

U.S. Patent Publication No. 2012/0043014 to Lim is another method in the art that discloses joining two rim barrel section portions together using a thermal process to compress the two together. The method includes an inner portion of the rim barrel and an outer portion of the rim barrel, wherein the inner portion is comprised of a fiber reinforced composite material and the outer portion is comprised of a metallic material. The outer portion includes the wheel spokes, the wheel lip, and a portion of the wheel barrel, which overlaps the inner, composite portion of the rim barrel. A mold is utilized to support the inner and outer portions after the composite has been stacked and during a heating process that cures the composite and bonds the two portions together via the pressure generated by thermal expansion during the heating process. The Lim method is limited to creating a composite wheel barrel section that is mated to a metallic material section, and does not contemplate use in the design of a composite spoke section. The Lim method further contemplates use of stacked directional layers of composite material, as opposed to a chopped fiber compression molding process as herein provided.

U.S. Patent Publication No. 2010/0090518 to Schiers discloses a method of fabricating a bicycle rim and placing the rim spoke holes in the barrel of the rim during the manufacturing process rather than cutting or machining the barrel after the composite has been cured. The method involves laying up a laminate on a mold prior to curing and inserting spoke hole pins through the laminate without causing discontinuities in the fibers. During the curing process, the pins establish the spoke and air valve holes through the rim barrel without cutting the fibers, which otherwise reduces their strength around the hole. Similar to the aforementioned prior art devices and methods, the Schiers method does not contemplate a new method of manufacturing a composite wheel spoke region using compressed chopped fibers.

Finally, U.S. Pat. No. 4,017,348 to Shumaker discloses a method of making a composite vehicle wheel for the high torsion load environment of heavy equipment and trucks. The resulting heavy duty wheel is manufactured using a chopped fiber reinforced epoxy resin that is surrounded by a winding of directional fibers to form the wheel barrel section, whereby the chopped fiber and directional fibers are supported and wound around a mandrel. While disclosing a composite wheel structure and method of manufacture using chopped fiber reinforced epoxy resin, the Shumaker device fails to anticipate the steps of the present design and manufacturing method, and further fails to contemplate the output and advantages of the present method, notably a composite wheel spoke section for one wheel design that can be formed and machined from a larger blank that requires no wheel-specific mold, mandrel, or wheel blank.

The present invention comprises a new design and manufacturing method of composite wheel spoke sections using chopped carbon fiber material, wherein the design process reduces material waste, reduces engineering design expense for each wheel design, and reduces the cost of composite wheels to consumers. A single mold is used to accommodate a plurality of wheel spoke designs, sizes, wheel offsets, and bolt patterns, whereby the resulting wheel blank from the single mold process is machined to a specific size and shape for the desired wheel. The resulting wheel spoke section is then bolted to a wheel barrel section to produce a lightweight, high performance wheel at a reduced cost compared to traditional methods of carbon fiber wheels in the market.

It is submitted that the present invention is substantially diverges in design elements and method steps from the prior art, and consequently it is clear that there is a need in the art for an improvement to existing composite wheel design and manufacturing methods. In this regard the instant invention substantially fulfills these needs.

### SUMMARY OF THE INVENTION

In view of the foregoing disadvantages inherent in the known types of composite vehicle wheels and associated design and manufacturing methods present in the art, the present invention provides a new design and manufacturing method wherein the same can be utilized for producing a composite wheel spoke section that reduces cost and wasted material to produce a lightweight, high performance wheel for competition or road use.

It is therefore an object of the present invention to provide a new and improved method of designing and manufacturing a composite wheel that has all of the advantages of the prior art and none of the disadvantages.

It is another object of the present invention to provide a new method of designing and manufacturing composite wheels, wherein the method includes a process of forming chopped carbon fiber material into a wheel blank that is machinable to the end design of the given wheel spoke section.

Another object of the present invention is to provide a design method for creating composite wheels in which one mold can be utilized to create a wheel blank that accommodates a plurality of different wheel spoke section designs, whereby the final design is machined from the singly designed blank.

Yet another object of the present invention is to provide method for composite wheel production that does not require analysis of individual ply layers at all locations of the wheel, wherein the present method does not require a specific layup schedule or layup mandrel for each wheel design being produced.

Another object of the present invention is to provide design method of composite wheels that aims to reduce the end price of composite wheels to the end consumer, while still retaining the primary advantages associated with composite wheels (light weight, high stiffness, high strength, greater fatigue life, etc.).

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates the first step in the present design method for choosing several wheel designs that are contemplated from a single wheel blank using the present method.

FIG. 2 illustrates how the several wheel designs are overlaid in the design stage to establish the boundaries of the wheel blank to be created using a single mold.

FIG. 3 shows a cross section view of the designed wheel blank and its ability to accommodate different bolt patterns, wheel offsets, wheel diameters, and spoke designs.

FIG. 4 shows how an example profile design for a single wheel to be created from the designed wheel blank, wherein the offset, bolt pattern, and wheel diameter are determined for the machining process.

FIG. 5A shows the compression molding machine utilized to inject the heated chopped carbon fiber material into a mold created using the present design method.

FIG. 5B shows the wheel blank mold that has been designed for different wheel shapes and optimized to reduce waste in the molding process.

FIGS. 6 and 7 show illustrative examples of the contemplated manufacturing processes, notably a compression molding process to create the singular wheel blank and a machining process to machine the final wheel design therefrom.

FIG. 8 shows a view of a finished wheel spoke section created by way of the present method, whereby the spoke section is fastened to a barrel section to form a complete vehicle wheel.

### DETAILED DESCRIPTION OF THE INVENTION

Reference is made herein to the attached drawings. Like reference numerals are used throughout the drawings to depict like or similar elements of the present method. For the purposes of presenting a brief and clear description of the present invention, the preferred embodiment will be discussed as used for creating a composite wheel spoke section using chopped carbon fiber material and a design process that minimizes waste and costs. The figures are intended for representative purposes only and should not be considered to be limiting in any respect.

The present invention is a new design method and method of manufacturing for vehicle wheel spoke sections using composite material, wherein the production of the wheel involves a forming process and the design method allows for multiple different wheel designs to be incorporated into a single manufacturing process. The design method reduces material waste and costs of the wheel for the end consumer, while maintaining the benefits offered by composite wheels. Specifically, chopped carbon fiber reinforced plastic is used to create the wheel spoke section, wherein the chopped fiber is placed into a mold, compression molded into a formed shape, and then machined into a final spoke design. The use of chopped fibers and a forming process allows designers and fabricators to machine the final design from a larger wheel blank, which allows one wheel blank to be utilized for multiple wheel designs without individually engineering each wheel and creating a specific mold for each wheel design. This eliminates the traditional composite layup process, which is labor intensive and design intensive, and requires a specific mandrel or mold for each wheel design.

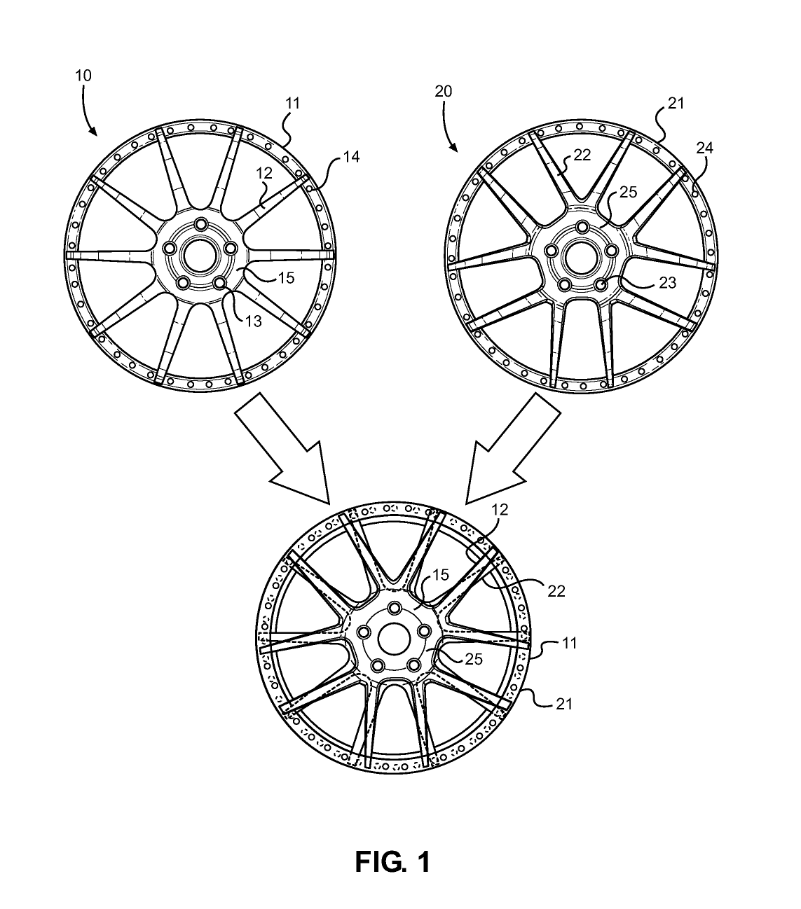

Referring now to FIG. 1, there is shown the first step in the present method, wherein the several wheel designs 10, 20 are chosen by the designer to be created from a single wheel blank. The wheel designs 10, 20 include different wheel spoke 12, 22 designs, different bolt 13, 23 patterns, different wheel hub designs 15, 25, and different wheel diameters 11, 21. These wheel designs are overlaid over one another in a three dimensional space, preferably using a computer aided design (CAD) tool for efficiency and accuracy. The wheels are concentrically centered in the design space to determine where the material of each wheel exists, wherefrom the overlap between the designs and the open spaces (voids) are determined. The area consumed in the overlap establishes where material must be present in the subsequent wheel blank to be created in the molding process. In this way, a single, larger wheel blank is created and utilized for different sized wheels, while the blank is optimized so that material is created in the blank only where necessary and those void areas are left open. In this way, unnecessary material use is reduced in the wheel blank to save costs and machining time.

Creating a large wheel blank is common in the fabrication of wheels from a metallic material, such as an aluminum or steel wheel. However, the wheel blanks for metallic wheels are usually large blocks of solid material not tailored to a specific set of wheel designs or optimized to reduce material cost. This is because metallic material is far cheaper in contrast to composite material. Therefore, the present method contemplates a new method that borrows from previous methods and produces a composite material wheel spoke in an efficient and cost effective manner.

For metallic material wheels, a large wheel blank (not optimized for any shape, generally) is machined using a computer numerical control (CNC) milling machine, wherein material is removed from the blank to create the final design. Since the material is isotropic and machinable, the wheel can simply be machined from a large bloc, and the unused material can be collected for reuse or recycling. For typical carbon fiber wheels and other composite material wheels, this process is not achievable, as the material used in the wheel is created using a layup process and a design process that takes into account the directional fibers of typical composite material systems. The design of each wheel is unique, including minor changes such as bolt patterns and wheel offsets. The layup directions and thickness in each area of the wheel must be determined, analyzed, and tested because of the unique material system and complexity of its fabrication process. Consideration must be given to the design shape and the ability of the directional fibers to bond and form a sufficiently strong and stiff structure where required.

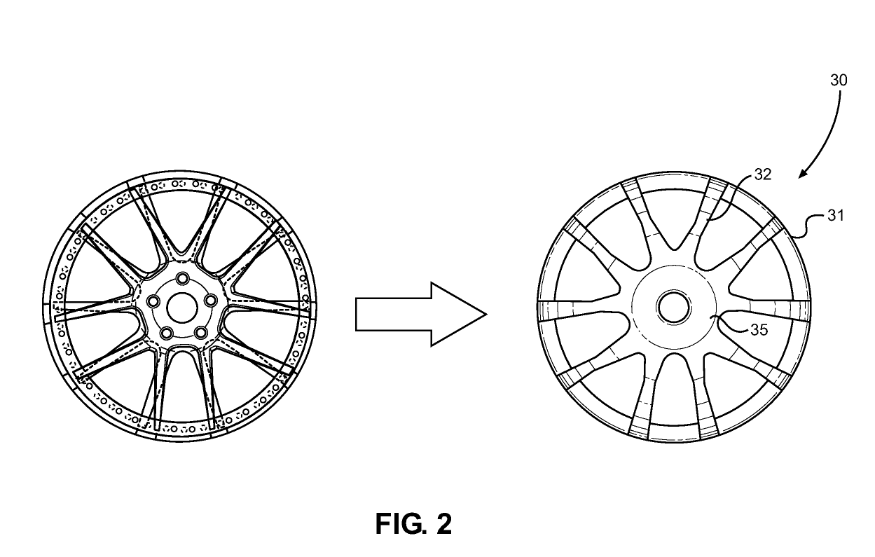

The present invention contemplates creating a composite wheel spoke section of carbon fiber, but rather than a layup process using directional fibers, the present invention method utilizes a chopped fiber compression molding process and a design process similar to metallic wheel fabrication but with improved efficiency and with greater front end optimization. Since chopped carbon fiber is more expensive than metallic materials, a shaped wheel blank is created from the combination of several different wheel designs, which can then be machined down to the exact wheel design chosen by the end customer. Chopped carbon fiber can be machined with ease using a CNC machine, while material costs are reduced in the optimized design process. FIGS. 1 and 2 illustrate how different wheel designs are overlaid onto one another in a design space to establish the shape of the wheel blank 30 to be created from the chopped carbon fiber material in a mold. The process can accommodate wheels of different diameter, spoke design, wheel offsets, hub design, and different bolt patterns, wherein the final product is bolted to a wheel barrel section to create a composite material vehicle wheel.

Referring specifically to FIG. 2, there is shown the final wheel blank design 30 created from the overlaid wheel design. The wheel blank includes material where the different designs overlap and voids where no material is required, creating an efficient mold that accommodates all of the different wheel spoke designs. Extra material is added to accommodate for engineering tolerances, any losses anticipated in the molding process, and any complex areas that will be difficult to mold and easier to machine excess after the wheel blank is formed. This design process creates a singular, optimized wheel blank design 30 to create a mold, wherefrom a chopped carbon fiber is compression molded into the wheel blank shape for later machining into the final product. The wheel blank design 30 includes a wheel hub region 35 to create different bolt patterns, offsets, and hub centers, enlarged spoke regions 32 to carve out smaller spokes therefrom, and a perimeter edge 31 that can be machined into different wheel diameters. This design process eliminates wasted material and eliminates the need to have a specific mandrel or mold for each wheel design, which is otherwise typical of composite wheels made from directional fibers.

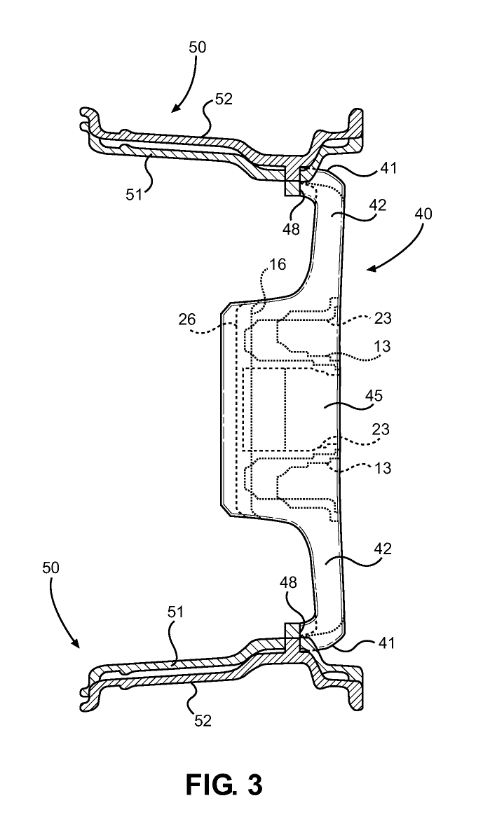

Referring now to FIG. 3, there is shown a cross section side view of the molded wheel blank 40 created by wheel blank design process of the present invention, wherein the singular wheel blank 40 is capable of being machined into a spoke section of desired diameter 41 and spoke/hub design. As illustrated, the outer perimeter of the wheel blank 40 can be machined to a diameter that accommodates larger 51 or smaller 52 wheel barrel sections 50. Since the perimeter 41 is bolted to the barrel 50, its outer extent is machined to a specific wheel diameter and the blank 40 diameter is created based on the largest anticipated wheel diameter to be machined.

The wheel blank 40 is the compression molded chopped carbon fiber material that has gone through the molding process and is a result of the design optimization discussed above. The spokes 42 of the composite wheel blank 40 are machined to a specific design, while the wheel hub 45 is tailored based on the requirements of the wheel and the vehicle receiving the wheel. Notably, the wheel offset 26, 16, the bolt pattern 13, 23, and the hub center is machined based on customer needs from the single blank 40. Therefore, the single blank 40 created in the molding process accommodates a plurality of wheel designs, shapes, and sizes.

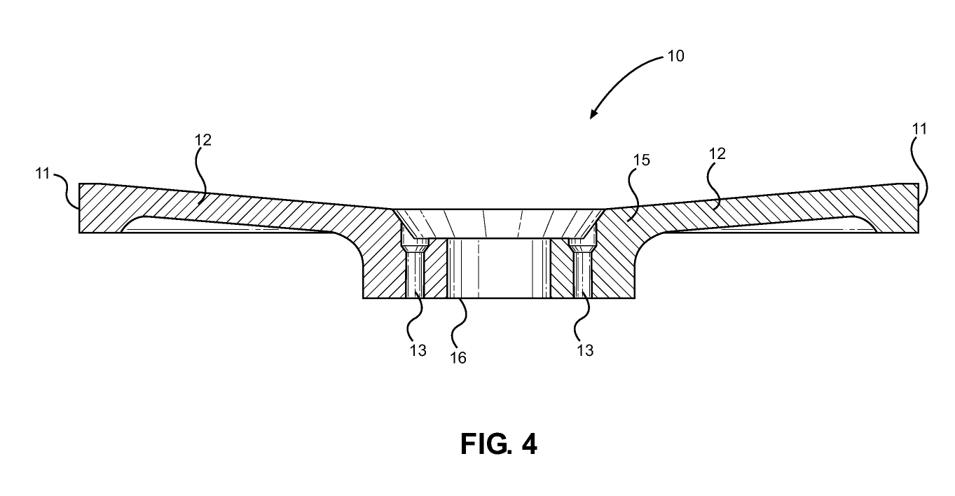

Referring now to FIG. 4, there is shown a cross section of the final wheel spoke section 10 created from the present method, after machining. The spokes 12 and outer perimeter 11 (diameter of the spoke section) have been machined to size, and the offset 16 and bolt pattern 13 has been milled to final specifications. If the wheel has an open central hub 19, this can also be milled. The final product of the present method is a wheel spoke section 10 for a three-piece wheel that is comprised of a chopped carbon fiber material, wherein the final design is machined from an efficient and optimized process to save cost and reduce wasted material.

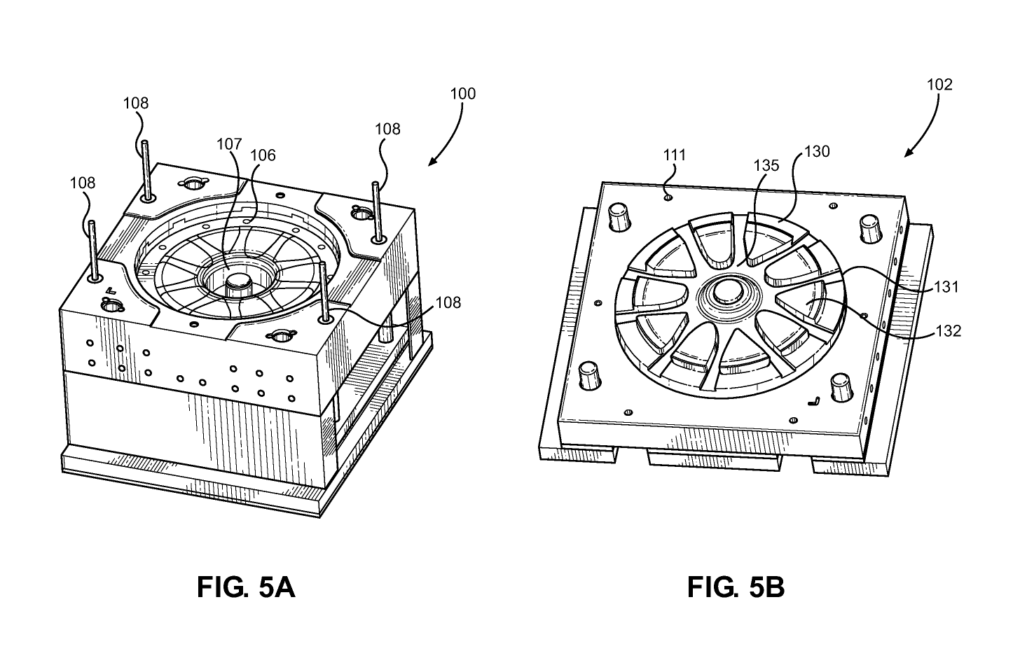

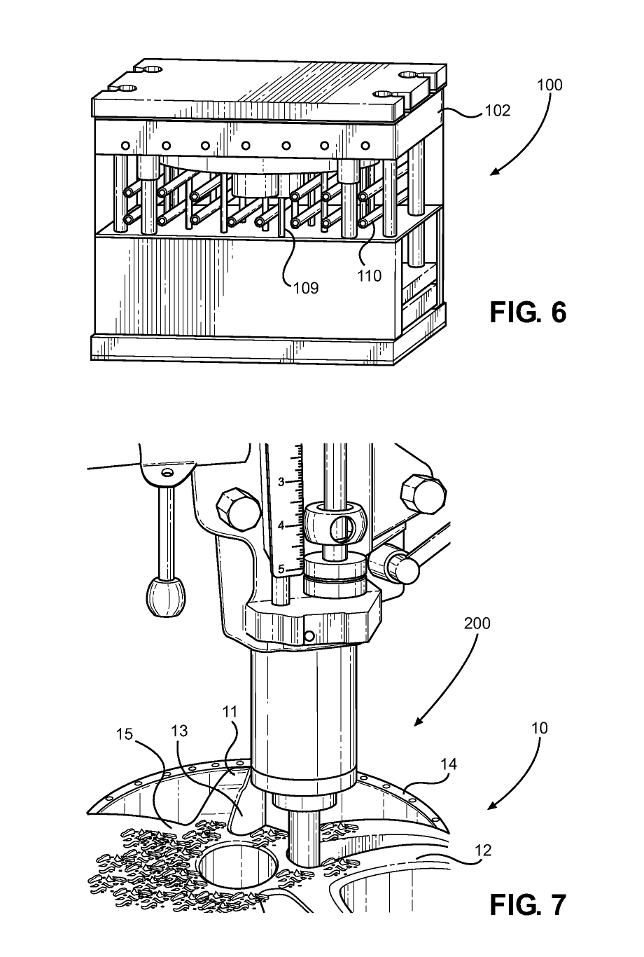

Referring now to FIGS. 5A, 5B, and 6, there are shown elements of the molding process that are utilized to transform the wheel blank design in a single carbon fiber wheel blank to be later machined to size and shape. The optimized wheel blank shape is utilized to create a reverse mold 102, wherein the voids 132 in design are filled, and the hub design 135, the outer perimeter 131, and spoke sections of the design are left open to accept heated and flowing material therein. Mold engineers and material engineers create a mold based on the wheel blank design that allows the material to flow correctly in the mold and will meet a number of important goals. These include allowing the part to be easily removed from mold 102, allowing the mold to fit correctly in compression press 100, correcting the hardness of mold materials, and other common compression molding issues.

Referring specifically to FIG. 5A, an exemplary embodiment of the compression press 100 used the molding process is shown. The mold 102 (FIG. 5B) is aligned with the press 100 using a plurality of dowels 108 that guide the mold into position via corresponding dowel apertures 111 (FIG. 5B). The mold is secured within an open volume 107 in the press, wherein heated chopped carbon fiber material is communicated into the mold 102 for filling out the voids therein. The mold 102 is compressed against the press 100 as the heated material communicates through ports 105 it the press, completely filling the mold and ensuring no open spaces or voids exist between the mold and the material. The material is then cooled and the press is released, whereafter the molded wheel blank can be released from the mold for subsequent machining. Referring to FIG. 6, the internal design of the press 100 is shown and the mold 102 is connected thereto. Injection pins 109 communicate the heated chopped carbon fiber material into the mold 102, while electrical heater elements 110 elevate the material temperature to allow for free flowing thereof (reduced viscosity). This process is well known in the art of compression molding and would be readily recognizable to one skilled in this art.

Once released from the mold, the carbon fiber wheel blank is machined into a final design. Referring to FIG. 7, there is shown this final step in the present method, wherein a CNC milling machine 200 or similar device is utilized to machine the larger wheel blank into the final wheel design 10, wherein the spokes 12, wheel hub 15, bolt pattern 13 wheel offset, and outer perimeter 11 are defined. The bolt pattern 14 along the perimeter edge 11 is also machined, wherethrough fasteners secure the wheel spoke section 10 to a wheel barrel section.

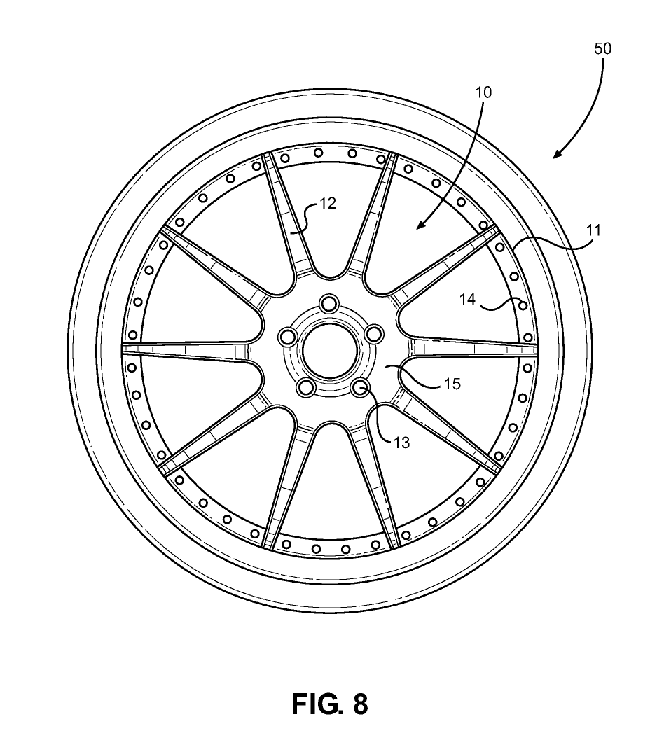

Referring finally to FIG. 8, the final wheel assembly is shown. The molded and machined wheel spoke section 10, comprised of the chopped carbon fiber material, is fastened to a wheel barrel section 50 to form a three-piece wheel. The spoke section perimeter 11 is fastened through apertures 14 therealong, which align with apertures in the barrel section 50, as is commonly known in the art of three piece wheels. The final bolt pattern 13 for the wheel hub 15, its offset, and the final wheel spoke 12 design is visualized.

Overall, the present method contemplates a new and novel method of designing and manufacturing a composite wheel spoke section for three piece wheels. The first step includes determining one or a plurality of different wheel designs. The designs are overlaid upon one another to determine the minimum shape of a singular wheel blank that can be created to accommodate all of the chosen wheel designs. The different diameter wheel designs are utilized to create the minimum perimeter shape of the wheel blank that will fit all diameters of the chosen designs. Next, the profile and cross section of each design is analyzed and the single wheel blank is made to accommodate these different designs, while minimizing material waste in the molding process. Material costs are calculated based on the weight of the singular wheel blank and the material required to mold the same. After the wheel blank shape is determined, a reverse mold is designed therefrom. The mold utilizes chopped carbon fiber material that flows into the mold using a heated, compression molding process. Once the finished wheel blank has been molded, it is machined down to a specific shape: namely, the desired wheel design. Different wheel diameters can be cut down from the wheel blank, while the bolt holes and the desired offset will be cut in this stage of the process. The final wheel design (spoke design) is now cut, and the wheel undergoes finishing. Finishing includes hand polishing of the carbon fiber or applying a clear coat of paint for cosmetic reasons and to seal the carbon. Finally, the carbon fiber wheel spoke section is fastened onto an outer barrel section to make the completed, three piece wheel.

It is contemplated that the present invention provides a reduced cost, leaner, and more optimized method of manufacturing carbon fiber wheels. The use of chopped carbon fiber material allows for a molding and machining process, rather than a mandrel layup process. The ensuing result is the ability to mold a single wheel mold that can be machined into a desired wheel shape, wherein design complexity and manufacturing considerations are reduced. Overall, the method reduces the cost of such a wheel to consumers, while sacrificing little in the way of wheel performance.

It is submitted that the instant invention has been shown and described in what is considered to be the most practical and preferred method steps. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function, steps, and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of designing and producing composite wheels using chopped carbon fiber, comprising the steps of:
choosing one or a plurality of wheel designs;
concentrically overlaying said wheel designs to determine a single wheel blank design;
creating a reverse mold of said single wheel blank design;
compression molding a wheel blank using said reverse mold;
machining said wheel blank into one of said wheel designs.

2. The method of claim 1, wherein said choosing said wheel designs further comprises the steps of:
determining the diameter, wheel offset, hub design, bolt pattern, and spoke design of said wheel designs prior to overlaying said wheel designs.

3. The method of claim 1, further comprising the steps of:
fastening said wheel design after machining to a wheel barrel section to create a three piece wheel.

4. The method of claim 1, wherein compression molding said wheel blank further comprising the steps of:
heating chopped carbon fiber;
communicating said chopped carbon fiber after heating into said mold;
compressing said material in said mold using a press;
removing said material after cooling.

5. A three piece composite wheel, comprising:
a wheel barrel section having a diameter and an internal ledge;
a wheel spoke section having a wheel offset, bolt pattern, outer perimeter, spoke design, wheel hub, and fastener locations through said outer perimeter;
said wheel spoke section comprising a molded, chopped carbon fiber material;
fasteners through said fastener locations securing said internal ledge of said barrel section to said outer perimeter of said wheel spoke section.
